(19) United States
(12) Patent Application Publication
(10) Pub. No.: US 2014/0272908 A1
(43) Pub. Date: Sep. 18, 2014

(54) DYNAMIC LEARNING SYSTEM AND METHOD

(71) Applicant: SinguLearn, Inc, Plainview, NY (US)

(72) Inventor: Barry Black, Sea Cliff, NY (US)

(21) Appl. No.: 13/839,363

(22) Filed: Mar. 15, 2013

(51) Int. Cl. G09B 5/08

(52) U.S. Cl. CPC G09B 5/08
USPC 434/362

(57) ABSTRACT

The invention contemplates a real time learning system and method with machine executed steps of creating a student learning profile based upon testing the student, and dynamically optimizing the learning profile based upon student responsive data to instruction. The method includes dynamically optimizing a curriculum based upon the dynamically optimized learning profile (DOLP) of the student and providing lessons or lesson guidance for the student based upon the dynamically optimized curriculum (DOC). The DOLP stores data including real time frequency curves of affect value versus success rate for multiple content delivery methods (DMs). Frequency curves of multiple DMs are compared and optimal DM amounts obtained. Affect value is a measurement of affective state based upon sensor data or determined sensor-free. Affective state may be engaged concentration, boredom, confusion, frustration, etc. A dynamically optimized teaching profile (DOTP) is contemplated. The DOLP and DOTP are based upon preliminary profiles.

### BACKGROUND

This application relates to computerized learning systems.

Second language acquisition is an active field. People learn a first language as children easily through personal interaction; however, the manner of learning language is heavily studied and not entirely understood. There are many theories regarding language learning. It is of great use to be able to learn a second language. Second language learning can be difficult especially later in life. Additionally, the ability to learn a second language is different than learning a first language and is also not fully understood. Language learning is studied to better teach and learn second languages or better teach and learn a first language.

Learning analytics is the measurement, collection, analysis and reporting of data about learners and their contexts, for the purposes of understanding and optimizing learning and the environments in which it occurs. It is the use of intelligent data, learner-produced data, and analysis models to discover information and social connections for predicting and advising people's learning. A related field is educational data mining.

Computer software and computers are known to be used to help second language learning acquisition. Rosetta Stone and Berlitz are companies that specialize in second language acquisition. Rosetta Stone is software based with CDs and DVDs that the learner (student) listens to or watches. It includes interactive language teaching software and is not limited to just lectures. The software has a predetermined course with lessons in vocabulary and grammar. The lessons have a fixed point of beginning and a fixed end point that students are guided through in self study. It is a pre-fabricated curriculum model.

Berlitz uses live teachers. Thus, it is extremely interactive with a live teacher. Berlitz has centers in many cities for language lessons. It is a one on one learning environment. There is little technological use in the learning. Handheld devices and CDs are used to supplement learning lessons. Some sessions are group sessions. Group sessions may be small groups with a lot of individualized attention from the instructor. The use of individualized language tutors emphasizes learning from communication. Its methods are not software driven. Learning differs from one instructor to the next. The instructors use different lessons. The system is instructor driven. Technology may be used to transmit the communications. Video conferencing, Skype or other technological means can be used so that the instructor can speak directly to the student(s).

Online teaching is well known. This is a development due to better bandwidth and increasingly quicker computer and internet capabilities. Language learning has moved to the internet and online individual or group lessons. With an online teacher students can be taught by an instructor far away. There is no commuting and classroom overhead can be reduced. There is no need to have a meeting place or class room or school buildings. Schedules are flexible and there are no time zone problems.

Many languages have numerous dialects. One can search for a teacher with the dialect that one wishes to learn. With online learning, there is no need for the teacher to be in a physical location that is near.

Rosetta Stone teaches just 2 versions of Spanish: Castilian and Latin. In actuality, there are over 40 dialects of Spanish. It would be desirable for a language learning system to provide instructors for all the numerous dialects of a language.

Both Rosetta Stone and Berlitz are online now. Language tutors have maximized the use of the internet with technologies like Skype. Berlitz provides one on one instruction via the internet. No other differences are provided from technological developments. Rosetta Stone provides people who monitor the progress of group online teaching. There is no connection of the software with any video from the online lessons.

### SUMMARY

In general, in a first aspect, the invention features a learning method, comprising the machine executed steps of: creating a learning profile of a student based upon testing the student; and dynamically optimizing the learning profile of the student based upon student responsive data to instruction.

In general, in a second aspect, the invention features a computerized data processing system, comprising at least one data processor configured to execute machine readable instructions, the data processor upon execution of instructions, controls the data processing system to perform the machine executed steps of: creating a learning profile of a student based upon testing the student; and dynamically optimizing the learning profile of the student based upon student responsive data to instruction in real time.

In general, in a third aspect, the invention features a data processing system, comprising: data processor; tangible memory modules, the memory modules having embedded therein computer readable instructions and stored therein a dynamically optimized learning profile of a student; and the instructions for dynamically optimizing the learning profile in real time.

Embodiments of the invention may include one or more of the following features. The method further comprises the steps of dynamically optimizing a curriculum based upon the dynamically optimized learning profile of the student and providing lessons to the student or lesson guidance to an instructor based upon the dynamically optimized curriculum. The dynamically optimized learning profile stores data regarding affective state. The dynamically optimized learning profile stores data regarding the method of content delivery the student best learns by. The dynamically optimized learning profile stores data regarding success rate. The data regarding affective state is real time frequency curves of affect value versus success rate. The method further comprises outputting instruction guidance to an instructor based upon the dynamically optimized learning profile. Frequency curves of affect value versus success rate for more than one delivery method are stored. Frequency curves of affect value versus success rate for more than one delivery method are compared to obtain optimal relative percentages of delivery methods.

The method further comprises creating a teaching profile storing data regarding teaching characteristics. The method comprises dynamically optimizing the teaching profile. The method comprises matching the teaching profile to the learning profile to select an optimal instructor for the student. The method further comprises providing guidance to the teacher based upon the teaching profile. Output evaluating the teacher is provided.

The method may be for learning language. The method may comprise sensor-free determination of affective state. The method may comprise inputting sensor data to determine affective state.

The computerized data processing system further comprises executing the steps of: dynamically optimizing a curriculum based upon the dynamically optimized learning profile of the student and providing instruction to the student based upon the dynamically optimized curriculum or curricular guidance.

The apparatus further comprises a dynamically optimized curriculum stored in the memory modules and computer readable instructions embedded in the memory modules, the instructions for dynamically optimizing the dynamically optimized curriculum in real time.

Affect value is a measurement of affective state and may be based upon sensor data or may be determined sensor-free. Affective state may include engaged concentration, boredom, confusion, frustration, among other traits. The best manner of teaching is determined. Measuring affective state, optimizing the profiles and adjusting the relative amounts of delivery methods are performed in real time. Optimal employable amounts of applicable delivery methods are obtained. The selected applicable delivery methods may be measured and expressed as percentages. The dynamically optimized learning profile and the dynamically optimized teaching profile are based upon preliminary or provisional profiles generated from blind assessment test responses to modify default profiles. The dynamically optimized learning curriculum is based upon a preliminary or provisional curriculum obtained from adjusting a default curriculum based upon the learning preliminary or provisional profile.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIG. 1 shows a schematic of the preliminary phase of the dynamic learning system of the invention.

FIG. 2 shows a schematic of the main phase of the dynamic learning system of the invention.

FIG. 3 shows an operation flowchart for the dynamic learning system of the invention.

FIG. 4 shows a computer and data processing system for the dynamic learning system of the invention.

FIG. 5 shows the input and analysis of sensor data, test responses and instructor input to arrive at data representing student affect value data and success rate data.

FIG. 6 shows a flowchart for creating a Dynamically Optimized Teaching Profile.

FIG. 7 shows an interrupt routine for selecting an optimal instructor after the initial selection.

FIGS. 8a and b show RAM maps for the dynamic learning system of the invention.

FIGS. 9a and 9b show RAM maps for the dynamic learning system of the invention.

FIG. 10 show partial detailed 3D RAM maps for the dynamic learning system of the invention.

FIGS. 11 and 12 show sample frequency curves for the dynamic learning system of the invention.

FIGS. 13 and 14 show ROM maps of the dynamic learning system of the invention.

### DESCRIPTION

The dynamic learning system of the invention records and dynamically adjusts and modulates, constantly and in real time, to the learning nature and habits of the student. It creates for each student a Dynamically Optimized Learning Profile (DOLP) which is repeatedly updated with additional data further describing the student's unique learning attributes. The more data available to the system through detection, calculation, analysis and/or input, the more accurate the analysis of the student's learning attributes and, correspondingly, the more accurate the DOLP.

The continually updating DOLP, in turn, enables the system to adjust the curriculum to accommodate the student's DOLP, guiding the instructor with a Dynamically Optimized Curriculum (DOC), which continually evolves to better conform to the student's DOLP.

The dynamic learning system of the invention has applicability to a variety of educational platforms, including language-learning, test preparation and tutoring in a large variety of subjects on multiple academic levels (elementary through graduate). Its core module can be integrated into various existing computer or web based learning platforms, such as college or technical classes offered online.

A dynamic learning system is provided. It can be an adaptive system. The system is interactive and adjustive. Video and online conferencing is employed for software and instructor learning sessions.

Software records how the student responds to questions and adjusts the lessons to the student. For example, the system will determine how the student learns best based upon initial responses to initial questions. The dynamic learning system tailors the subsequent lessons based upon the manner in which the student best learns. The dynamic learning system asks initial questions and based upon initial answers determines which of the following manners of learning or learning delivery methods the student best learns by: visual learning, auditory learning, repetitive learning, learning by listening to lecture, learning by writing, learning by reading, learning by listening to spoken second language, memorizing, learning by speaking, or a combination of two or more of these. Other learning manners according to learning theory may be tested for. Then, the system adjusts future lessons to use that manner of learning (delivery method) or a statistical or proportional combination or amount of delivery methods. The delivery amount may be computed or expressed as percentages. For example, the lessons may be adjusted to employ 60% visual learning, 20% auditory learning, 10% repetitive learning, 5% learning by listening to spoken second language and 5% learning by speaking. Thus, the dynamic learning system identifies the best way for this particular student to absorb the information and modifies a student profile to designate the best manner or type of learning to be used for the student. Then, the dynamic learning system adjusts the lessons to teach employing that type of learning or emphasizing that type of learning.

The learning method may be dependent upon the student's affective state. Affect value is a measurement of affective state and may be based upon sensor data or may be determined sensor-free. Affective state may include engaged concentration, boredom, confusion, frustration, among other traits. The best manner of teaching is determined for the student's current affective state. The measurements of affective states are stored for varied best manners of learning. The student's affective state is measured in real time.

The system is dynamic and records data in real time and modifies the student profile in real time. Additionally, the curriculum and the lessons or guidance to the instructor based upon the student profile are modified in real time. The amounts or proportional percentages of delivery methods for teaching are adjusted in real time.

The system is interactive. A sophisticated software program adjusts the lessons to the student. The system monitors the student's performance and adjusts the lessons based upon that performance by updating a student profile and adjusting future lessons based upon the student profile. The learning system identifies the student's strengths and weaknesses based upon responsive data. The system adjusts the lessons in accordance with those strengths and weaknesses to maximize use of the strengths and help to rectify the weaknesses.

This adjustability is not found in the prior art methods of language acquisition such as that used by Rosetta Stone that is non adaptive.

The inventive system guides an instructor. Thus, the inventive system has the advantages of a one on one instructor system like Berlitz, but improves upon that system by providing the instructor with guidance. For example, the software analyzes the student's answers to preliminary questions, determines that the student best learns by visual pictorial instruction, updates the student profile with that information about the student, advises the instructor that the student is one that learns best based on visuals and adjusts the future lessons to include visuals. Thus, the instructor is advised of the theory of learning to use for this particular student and is guided by the dynamic learning system of the present invention. The instructor is provided guidance in real time. The present invention has the benefits of live instruction and complete interactivity that goes with live instruction; and software guidance and instruction and computerized learning analysis. The present dynamic learning system provides continual feedback based upon learning analysis. A live instructor acting alone can not analyze the student responses and provide this real time feedback and immediately adjust the curriculum based upon the learning analysis. There is computer analysis of student responses to guide an instructor. The present system uses a combination of software computerized teaching and a live instructor who has the benefit of computerized learning analysis. Particular learning sessions may be with or without a teacher present connected to the system. Thus, a student can use the system for a learning session alone on the system at night in bed to do homework lessons or just read or review a session's lesson again for repetition, take notes or just review notes.

The interactive dynamic system creates a student profile which is repeatedly updated as the student responds to questions. Future lessons are based upon the updated student profile. This is a computer online based interactive education instruction for purposes of language acquisition. There is real time feedback and the feedback is fed into the computer for providing an instructor with guidance in teaching. The curriculum is modified based upon the student profile. The student profile is dynamic and continually updated. Preferably, every time the student uses the system, the student profile is being constantly updated. The student can choose to suspend or pause the updating operation for a particular session. The lessons are dynamic, continually modified based upon the dynamic student profile. The lessons are adjusted in real time. The teacher is provided guidance in real time.

In the present invention, the system is not just determining that the student missed 9 of 10 exercises on past tenses and should be given more lessons on past tenses. The inventive system goes beyond that and determines that the student learns by hearing the tenses conjugated and provides the auditory lessons with providing instruction to the teacher or determines that the student learns by writing the conjugations and provides the written exercises, again providing instruction to the teacher.

Computerized learning analysis is used to create a student profile that is constantly updated. The student profile includes data regarding the best manner of teaching this particular student. This dynamic student profile is used to modify the curriculum and provide guidance to an instructor. The teacher is assisted by the computerized software. The system optimizes the learning experience.

The student profile can also record affect value data that may depend on time based situations such as whether the student is a visual learner at night, for example, or when tired, or whether the student prefers to read at night. The student profile may record affect value data that may depend on mood. Other qualities of the student can be part of the student profile such as stress level or anxiety level reflected in the affect data.

When a student who already has a profile created starts a new learning session, questions are asked to determine characteristics like tiredness. This data is immediately input to determine an affect value, and a best manner of learning for this particular criteria is determined. The best manner of learning controls the adjustable curriculum. When the student is not tired and has better concentration, the affect value obtained from that input determines the best manner of learning for the different circumstances and that controls the curriculum. The student may begin a session and immediately input data indicating a characteristic such as tiredness to immediately employ a proper curriculum for the circumstances without the need for questions or sensor data to determine affect value.

Voice recognition software can be used to determine the student's performance in speaking. A grade or performance indicator can be recorded as part of the student profile. There are multiple performance or grade indicators for a multitude of skills graded. When the student's performance meets a level of proficiency, the course curriculum is modified to increase difficulty. Speech synthesis software and hardware are employed for auditory lessons.

Eye trace or tracking software can be employed to measure and determine student qualities or affective state. An affective state may be one such as tiredness. Sensors such as eye scanners input the eye tracing data including rate of blinking and pupil dilation. Skin sense sensors such as galvanic skin sensors and analytic software can be employed to measure and determine student affective states. The affective state may be a quality such as stress and/or anxiety. Sensors such as galvanic skin sensors input the skin sensory data. Heart rate data from sensors can be employed to measure student qualities or affective state. Sensors that measure breathing can also input data which is analyzed to measure and determine student qualities or affective state.

This is generally called affect detection and software determines an affect value aV based upon affect detection. The input data from the various sensors is combined to arrive at an affect value aV. Alternatively, affect value may be determined sensor-free. Sensor-free affective state measurement may be combined with affective state measurement based upon sensors to obtain an affect value. The sensor based measurements may be combined with the sensor-free data by any known function. The simplest function is to add and divide by two or the number of sources of data. Alternatively, more sophisticated functions may be employed. The sources of data may be weighted. The weights may be preprogrammed or determined by the system. The sensor based and sensor-free data may be weighted. For example, the total affect value aV may be obtained as follows

aVₜₒₜₐₗ=A(aVₛₑₙₛₒᵣ)+B(aV_{sensor-free})

where A is a weight and B is a weight.

A may be 80% and B may be 20%, for example.

Affect detection programs are known to provide measurement data of different affective states. For example, in Towards Sensor-Free Affect Detection in Cognitive Tutor Algebra, by Baker, R. S. J. d. and Gowda, S. M., et al., International Educational Data Mining Society, Jun. 19-21, 2012, the following algorithms are identified as providing measurements for certain affective states: the algorithm K* for measuring engaged concentration, the algorithm JRip for measuring confusion, the algorithm REPTree for measuring frustration, the algorithm Naïve Bayes for measuring boredom. These algorithms or other known affect detection programs for measuring different affective states may be employed. Instructions can be input to use just some of the affective states available by the system. For example, the affective states of engaged concentration and boredom can be used even though frustration and other affective states are also available but not in use.

The dynamic language learning system also develops teacher profiles. The teacher profiles include data regarding the language the teacher teaches as well as the dialect of the language. The system includes a search engine for searching for an instructor that teaches the language and dialect that the student wishes to learn and for matching the student to the teacher. Since the lessons are by video conferencing or a technology such as Skype or other online technology, the teacher and student do not have to be in the same area or country. They can nevertheless be matched and schedule the sessions at their convenience based on their individual schedules. The pool of teachers is increased. Thus, the system can accommodate teaching all dialects of all languages.

The teacher profile can also include data regarding fields that the teacher can emphasize. So for example, the data can indicate that the teacher can emphasize legal jargon, business jargon, or technical jargon and a technical field like medical, electronics or chemistry. This is helpful for a student who is seeking a teacher for learning a language for career purposes such as for legal work or scientific research work or engineering, or any other specialized field.

The teacher profile, also called the Dynamically Optimized Teaching Profile (DOTP) records data about the teacher. The recorded data may include teacher attributes like habits and information regarding interactions with students. The data can record the number of times the instructor interrupts the student, for example. The data can record how fast the teacher speaks. The teacher can be evaluated in real time. Teaching analysis can be done in real time or periodically. The instructor's performance can be graded. Numerous teaching skills are independently graded. Based upon the teacher profile, the curriculum can be modified or the instructor can be changed. The teacher's profile data that indicates emphasis regarding manner of teaching can be compared to the student's profile regarding the manner of learning that the student best absorbs information in order to determine if the teacher is the best teacher for the particular student. Thus, the teacher profile is compared to the student profile to determine if there is a good match even after instruction has begun. The matching of student to teacher does not end with the initial comparison to find the instructor. For example, Mr. A may be the best teacher for teaching beginners, but as the student progresses, Mr. B may be better for teaching a more advanced student. Thus, the system may determine that the student should switch from Mr. A to Mr. B as his teacher. Further, when the student progresses further and wishes to learn language associated with the field of banking, the system may determine that Mr. C is the best teacher for the jargon associated with that field, and the system may suggest to the student a switch to Mr. C as his instructor.

The system personalizes the learning experience. Learning and teaching analysis are interwoven and function simultaneously. Both teacher and student are monitored in real time and matched up to complement each other and enhance the learning for the student. The lesson plan is adjusted and personalized to the student and to the student/teacher interaction.

The preferred embodiment is now described in more detail.

The dynamic learning system operates with two phases, an initializing phase, called the Preliminary Phase 100, and a standard operating phase, called the Main Phase 200. FIG. 1 shows a schematic of the Preliminary Phase 100 of the dynamic learning system of the invention. FIG. 2 shows a schematic of the Main Phase 200 of the dynamic learning system of the invention. Shown are the student 1 and the instructor 2 in both phases.

Preliminary Phase

Reference is made to FIG. 1 showing the Preliminary Phase 100. The Preliminary Phase occurs once, in order to achieve an initial or preliminary student profile. It is significant not only in accelerating the achievement of a DOLP by providing the dynamic learning system a fairly accurate preview of the DOLP called the Provisional Learning Profile, but also for the purpose of assisting the dynamic learning system in the crucial step of determining the initial optimal instructor for the student in question.

The goal of the Preliminary Phase is to determine an initial, albeit imperfect, learning profile (the Provisional Learning Profile 105), based upon which the dynamic learning system can determine an appropriate instructor. It does so by use of a standardized Blind Assessment Test 102 which broadly measures the student's learning attributes and a standardized Blind Assessment Test 112 which broadly measures the instructor's teaching attributes. Thus, an instructor well-suited for the particular student's Provisional Learning Profile 105 can be selected.

A Default Learning Profile (DLP) 101 is programmed into the system. The DLP generated by the dynamic learning system is based upon the mean value for each element in a student profile in the preferred embodiment. After a large population is tested, the DLP may be based upon the results of those tests. The DLP is modified in the Preliminary Phase to develop the Provisional Learning Profile (PLP) which is the basis for a potential DOLP developed in the subsequent Main Phase 200.

Referring to the Preliminary Phase 100, each student's profile considers various predetermined learning characteristics of a student in the given discipline. For each learning characteristic, there is a range of possible points on which a particular student may fall. The mean value for each such learning characteristic is set as a starting point in the default profile DLP for the preferred embodiment. The dynamic learning system uses the conglomerate of all such mean values as the DLP. In short, the DLP is designed as a generic profile of a hypothetical average student. It is defined by the mean for each learning attribute in the preferred embodiment. The DLP has no correlation to the subject student.

Table 4 is a list of many possible affective states considered in a potential profile. The list is not exhaustive and many other learning characteristics can be added to the dynamic learning system. Affect detection, as a field, is growing and measuring an increasing number of different affective states.

For example, one element in a potential profile may be a rating for memory. The average student may be assigned a memory rating of 5. This mean value is part of the profile and the DLP will be based upon a student with an average memory. This value will be adjusted in the Preliminary Phase and the Main Phase based upon the student's responses to questions.

The elements in the profile such as memory are affective states. Other affective states may be engaged concentration, boredom, confusion, frustration, among other traits.

The elements are measured for different delivery methods or manners of learning. An affective state may be dependent upon the delivery method. Thus, for example, memory may be better when the manner of learning is visual. The average student may have a rating of 5 for the mean value for memory for visual learning. This mean value is part of the profile and the DLP will be based upon a student with average capacity for memory for learning visually. This value will be adjusted in the Preliminary Phase and the main phase based upon the student's responses to questions.

Further in this example, the element of memory may be measured for the manner of learning—learning by writing. The average student may have a rating of 5 for the mean value for memory for learning by writing. This mean value is part of the profile and the DLP will be based upon a student with average capacity for memory for learning by writing. This value will be adjusted in the Preliminary Phase and the Main Phase based upon the student's responses to questions.

Affect detection in accordance with known algorithms and functions is used to arrive at a measure of the overall affective state for a delivery method. Affect detection is a growing field and new functions and algorithms are being developed to measure affective state. The system and method of the invention may be readily adapted to adopt new algorithms and functions for arriving at a numerical value to designate affective states. The overall measure of the combined affective states is called the affect value aV. Numerous measures of different affective states may be combined to arrive at an affect value aV using algorithms and functions. The simplest such function is to add the different measures of affective state and divide by the number of different measures of affective state. Thus, if there are measures of affective state for four affective states (engaged concentration, confusion, frustration, and boredom), the aV may be obtained by adding the four values and dividing by four.

The affect value aV may be any function of the measures of the different affective states determined by tests and learning experts, theory and analysis.

aV=f(w, x, y, z, . . . )

where w, x, y, z, . . . are measures of different affective states.

In a preferred embodiment, a method, more sophisticated and effective than adding measures of different affective states and dividing by the number of different affective states is employed. The preferred method employed is to assign different weights or significance to the different affective states.

aV=aw+bx+cy+dz

where
w is the measure of the affective state engaged concentration
x is the measure of the affective state confusion
y is the measure of the affective state frustration
z is the measure of the affective state boredom
and a, b, c and d are % weights. For example, a may be 60%, b may be 20%, c may be 10% and d may be 10%. The weights may be preprogrammed or determined by the system. There may be more or different affective states and each are measured and determined for different delivery methods.

A Blind Assessment Test (BAT) 102 is performed on the student. In order to preliminarily find an optimal instructor appropriate for the subject student, the BAT is administered. The BAT is a standardized objective measure designed to identify and profile an individual's learning characteristics. The nature of the test can not be discerned from the individual items or questions; and as such can be regarded as and is designed to be, an effective test of the real qualities of a subject student's learning faculties, rather than an assessment of the student's self-reflective notion of his or her qualities. Self assessment can be inaccurate. The BAT comprises several hundred questions in the preferred embodiment. The student provides test responses 103 to the BAT 102.

The BAT necessarily begins with questions regarding language to be learned and dialect to be learned. Questions also pertain to whether the student wishes to learn the language for career or personal reasons and to whether there is a field the student wishes to communicate about such as legal, business, or technological and the technological specialty. Questions proceed to relate to the categories of information relevant to a student's learning nature.

The dynamic learning system analyses the student's BAT responses 103 at step 104 to create a Provisional Learning Profile PLP 105 also called the preliminary or initial student profile.

The system stores numerous categories of information about the student in the learning profiles. The system first stores basic information about the student referred to as Pedigree Variables. Table 1 gives a list of potential Pedigree Variables. The Pedigree Variables are used in the initial analysis stage 110 to make the initial match up of the student to an instructor. The Pedigree Variables are used to initially determine the optimal instructor in the Preliminary Phase and any subsequent match up as set forth with respect to FIGS. 6 and 7.

TABLE 1
Pedigree Variables

Language to learn
Dialect to learn
Career or Personal need for language
Field (legal, business, technological, . . .)
Subfield (banking, electrical, medical. . . .)
Schedule
Time zone issues based on location
Level of knowing language to be learned
(beginner, intermediate, advanced)
Age
Sex
Educational level
Number of other languages known or learned
Native Language

Additionally, the system stores data regarding grades for learner performance of particular skills as shown in Table 2.

TABLE 2
Grades for Learner Performance of Skills

Grade Skill 1 - vocabulary
Grade Skill 2 - pronunciation
Grade Skill 3 - tenses spoken
Grade Skill 4 - tenses written
.
.
.
Grade Skill 100 - Inflection for dialect

The system further stores data from which it can determine student responsiveness to different content delivery methods to determine the content delivery method the student learns best by or a combination of delivery methods. The combination of delivery methods may be designated as percent weights, for example 80% visual delivery and 20% by repetitiveness. Table 3 lists many possible content delivery methods for which the system can store data. The list is not exhaustive. Not all methods listed need be employed. When the system is used for learning in fields other than second language acquisition or language study, some of the methods may not apply and others methods, like practice problem solving for teaching mathematics or science, may apply.

TABLE 3
Content Delivery Methods
Manners of learning the student best learns by

Visual (nonverbal) stimuli;
Written (visual verbal) stimuli - native language;
Written (visual verbal) stimuli - second language;
Auditory stimuli (music, etc.);
Spoken stimuli - native language;
Spoken stimuli - second language;
Speaking (self);
Writing (self);
Memorization;
Repetition;
Listening to a lecture and note taking.

Affective states are measured and data measuring those affective states is stored for each of the content delivery methods. Table 4 lists many possible affective states for which the system can store data. The list is not exhaustive. Not all affective states listed need be employed.

TABLE 4
Affective States

Engaged concentration
Confusion
Frustration
Boredom
Result orientation (will become frustrated with negative results)
Patience
Anxiety
Self-dependence (vs. dependence on others for direction)
Skepticism (willingness to accept unknown premise)
Random vs. sequential learner
Orderliness
Detail orientation
Distractibility/Attention span
Social orientation
Reward orientation (enjoys positive feedback)
Motivation (to learn the language)
Memory
Number of hours awake/degree of tiredness
General state of mind/mood
Degree of relaxation (e.g., is student rushed?)/anxiety/stress
Fear (susceptibility to intimidation)
Duration of present learning session so far
Amount of time available for session (rushed)
Time of Day (morning person v. night owl)

Algorithms and programs measure these affective states using affect detection. For example, in Towards Sensor-Free Affect Detection in Cognitive Tutor Algebra, by Baker, R. S. J. d. and Gowda, S. M., et al. the following algorithms are identified as providing measurements for certain affective states: the algorithm K* for measuring engaged concentration, the algorithm JRip for measuring confusion, the algorithm REPTree for measuring frustration, the algorithm Naïve Bayes for measuring boredom. These algorithms or other known affect detection programs for measuring different affective states may be employed. Affect detection is a fast growing field with many new programs being developed for measuring different affective states.

Sensor data, responses to questions and instructor input are analyzed to arrive at affect value data, aV which is recorded. The aV is based upon measurements of affective states.

Affective states may be measured employing sensors input or by a sensor-free manner. The data based upon sensor input is combined with data obtained by a sensor-free manner in accordance with a function. The function may be adding data based upon sensor input and data obtained by a sensor-free manner with relative weights expressed as percentages based upon significance. The weights may be preprogrammed or determined.

Measurement data of different affective states is combined in accordance with a function. The function may be adding data of different affective states with relative weights expressed as percentages based upon significance. The weights may be preprogrammed or determined. The result is a total affect value.

The affect value data is graphed as a frequency curve against success rate SR which is a measure of if the student responded correctly. Success rate is a measure of success or failure (hit or miss) (right or wrong) in performance of the subject matter. Frequency curves of affect value aV versus success rate SR are generated for different content delivery methods and compared. The best delivery method that the student learns by is determined. The result is recorded. The system records the data in memory and adjusts the lessons to emphasis that type of learning. It may be determined that there are a number of delivery methods that the student best learns by in accordance with weights expressing significance. Thus, it may be determined that the student best learns by a combination of 60% visual instruction, 20% verbal instruction, 10% written instruction, 5% repetition and 5% memorization. Instruction is provided to the student or instruction guidance is given to the instructor based upon the results. All measurements and calculations are performed in real time and constantly updated.

Additionally the system may have inputs to request a particular mode when the student wants just a quick lesson, when the student is in a hurry, or picks a mode of operation such as to just read a book or repeat a particular lesson or play a recording of vocabulary with music in the background.

Based upon the affect value the system may suggest terminating a session. Thus, if the affect value indicates that a student is too tired, the session may be terminated.

In the Preliminary Phase of FIG. 1, the BAT 102 asks one or more questions, whose responses are analyzed at 104 to determine a provisional learning profile.

To determine the best manner of learning for a student, the BAT 102 actually gives a short lesson emphasizing visual learning and then asks questions to see how well the student learned the subject matter. If the student scores well on the short test, the student gets a high success rate value for visual manner of learning. The same is done with other methods of learning: auditory, repetition etc.

Other characteristics are also tested for and the data is analyzed. Thus, there are tests for the various affective states. For example, there may be tests for whether a student is reward oriented. The tests can be highly psychological in nature and can be customized by expert psychologists and social scientists. Tests can have sensory detectors such as heart rate detection for anxiety or stress, skin sensors for detection for anxiety or stress, or eye movement detection for attention span or tiredness. Distractibility and attention span is tested employing a timer and state of the art diagnosis software used to help diagnose attention deficit disorder. Social orientation is tested by asking the student questions about himself and his social interactions. The system can be adjusted to accommodate any type of psychological testing and personality testing developed pertinent to learning. Some of the questions in the test may be directed to the student's self assessment of his personality characteristics; however, preferably the characteristics are objectively measured. In the main phase, the values for various characteristics are determined not just on the basis of testing the student, but also on the basis of input from the teacher. Thus, a teacher can input that the student is impatient and easily frustrated or lacks motivation to achieve. The data input from sensors is analyzed to determine the student's characteristics at the time the detection is made.

A key benefit of creating the PLP is that a well-matched instructor may be initially selected to suit the student's unique learning style. At step 110 the Provisional Learning Profile PLP 105 is compared to a Provisional Teaching Profile PTP 115 which is explained further below. The Optimal Instructor is selected at 120 based upon the Provisional Learning Profile PLP. The Optimal Instructor Selected 120 is also based upon a Provisional Teaching Profile PTP 115. For example, a very visual student who responds better to a soft-spoken but strict, middle-aged instructor and who requires frequent repetition of certain curricular content may be preliminarily matched up with an instructor who is soft-spoken, strict, and middle aged. The PTP 115 records data regarding variables like teacher volume, teacher strictness, and teacher age in order to match up preferences. Preferences for teacher volume, teacher strictness, and teacher age may also be stored in the PLP 105. In this example, affective states are measured for numerous content delivery methods to determine the content delivery method the student best learns by. The measured affective states could be engaged concentration, fear (susceptibility to intimidation) or confusion. Analysis compares the data for different delivery methods and identifies that the student relates best to a content delivery method of learning-visual, and a content delivery method of learning-repetition. The instructor is given guidance to use visual learning and repetition and/or the PTP 115 may record data that this instructor uses visual learning and repetition for making the initial match up. The instructor pairing may change at a later time in the Main Phase as the student profile is optimized and updated or at the student's request.

Though the BAT 102 has provided the dynamic learning system a fair glance at the student's aVs as reflected in the newly generated PLP 105, the dynamic learning system has a long way to go to achieve a near optimal DOLP and dynamic, guided Dynamically Optimized Curriculum (DOC).

Teaching Profile TP

Each instructor is profiled also. With reference to FIG. 1, a blind assessment test BAT 112 uniquely designed to measure the instructor's natural and typical communication and teaching skills and attributes is administered. In addition, the instructor's other relevant data are recorded, including pedigree information and questions about habits, hobbies, experiences, avocations, etc. The test responses 113 are analyzed at 114 and used to modify a default teaching profile DTP 111 to arrive at a Provisional Teaching Profile 115. The system has a data base of teaching profiles TPs.

Because we learn better from those who share our communication modalities, it is crucial that the student be provided with an instructor whose communication style matches the student's learning characteristics. A key benefit that flows from the PLP is the dynamic learning system's ability to optimize the selection of an instructor for the profiled student, one who suits the student's unique learning style as set forth in the PLP 105. The dynamic learning system then performs a logical sequence which matches the PLP 105 against its database of TPs, seeking the best match based upon a predetermined compatibility formula. Step 110 performs the analysis. A search engine may be used to search for the teacher and perform the matching.

In addition to assessing the student's PLP 105 relative to the instructor's TP, other factors are analyzed via keyword comparisons, including vocation-specific, locations-specific, jargon-specific or dialect-specific considerations. For example, in the language-learning platform, a student seeking to learn how to speak Spanish in the dialect spoken in Buenos Aires and who dances Argentine tango, will find a Spanish teacher from Buenos Aires who is familiar with Argentine tango and its unique and familiar lingo. On the other hand, an American attorney seeking to do international arbitration in Paris may learn to speak French as spoken by Parisian arbitrators and lawyers.

It should be noted that, though the instructor's TP is deemed significant in terms of optimal instructor selection, the dynamic learning system ultimately guides all instructors toward providing the appropriate curriculum regardless of the instructor selected. Nonetheless, a natural, “good fit” synergy is beneficial, as it increases the likelihood of an optimal learning environment.

As the student continues to interact with the system, a change of instructor may be recommended. For example, while a student may be a good match with a certain instructor at an introductory level, a different instructor may be preferred at an advanced stage.

Main Phase

In the Main Phase 200, the dynamic learning system captures data from the student in real time, analyzes it and dynamically optimizes the student's learning profile. Based upon this Dynamically Optimizes Learning Profile DOLP, the system determines the instruction to be delivered by the instructor and adjusts the curriculum.

A Default Curriculum (DC) 201 is programmed into the system. The DC 201 generated by the dynamic learning system is based upon the Default Learning Profile DLP 101 for a hypothetical average student.

Referring to the Main Phase 200 shown in FIG. 2, each student's profile considers various predetermined Learning Characteristic traits, including affective states measured by affect values aV, of a student in the given discipline. For each affective state, there is a range of possible points on which a particular student may fall. The mean value for each such element is set as a starting point in the DLP 101. The conglomerate of all such mean values is used in determining the DC 201. In short, the DC 201 is designed for an average student. It is defined by the mean for each learning attribute. The DC 201 has no correlation to the subject student.

Analysis of the PLP 105 to adjust the DC 201 occurs at 202. A Provisional Curriculum (PC) 203 is developed based upon the PLP 105, the initial student profile. The system logic preliminarily modifies the DC 201 to the extent that the PLP 105 indicates upward or downward departures for each affective state to create the PC 203 with accordant modifications to the curriculum's general quality and proposed next steps.

For example, if the dynamic learning system determines that the student's success rate SR for a particular affect value aV should be increased based upon a successful response, it will record that upward adjustment as part of the DOLP, and the lesson plan is adjusted accordingly, to better match the student's ideal learning condition and optimize the overall teaching effectiveness.

Dynamically Optimized Learning Profile

Based upon the PLP 105, the dynamic learning system generates an optimal Dynamically Optimized Learning Profile DOLP and Dynamically Optimized Curriculum DOC. The following repeating process achieves this goal.
1. Guided by the dynamic learning system, the instructor and system proceed to deliver instruction 204 to the student based on the PC 203.
2. The student's Responsive Data (“RD”) 205 is recorded by the system. The data includes:
   Written and verbal responses to the instructor's inquiries;
   Written and verbal responses to examinations or quizzes;
   Written or spoken conversation;
   Facial, visual or other physiological expressions.
The RD 205 is captured and recorded in two ways: by the system and by the instructor.
By the dynamic learning system—Depending upon the nature of the RD 205, the dynamic learning system may automatically capture and record it at 206.
Written RD 205 is recorded by the system instantaneously. For example, the dynamic learning system will readily identify and record incorrectly spelled or implemented words or phrases and physical activity such as tracking mouse movement or rapidity of responsiveness.
Spoken RD 205 can similarly be captured by the dynamic learning system via voice recognition technology.
By the instructor—The instructor records verbal, written and visual (e.g. facial and gestural expressions, vocal variations and nuances) RD 205 and records the data via user-friendly on-screen tools which are specifically designed for rapid entry in real-time student-teacher interaction at 207.
3. The RD 205 is evaluated at 208 against the aV data of the PLP 105 to arrive at a Dynamically Optimized Learning Profile DOLP 209. As the system operates, further adjustments are made to the DOLP 209. The system logic, employing sophisticated algorithms developed with the assistance of leading language-art experts, academics and theorists, digests, analyzes and crunches the data to optimize the DOLP 209 accordingly.
The basic assumption is that each aV carries a certain relative weight in terms of its impact on the quality of instruction to be delivered. For each bit of data received analyzed and interpreted by the system, the aVs are adjusted accordingly. As data flow in, the system captures them and dynamically modifies the DOLP 209 in real time. The more the data, the more accurate the student profile.

Dynamically Optimized Curriculum

The Provisional Curriculum 203 is modified at 210 in accordance with the DOLP 209 to arrive at a Dynamically Optimized Curriculum DOC 211.

Armed with an ever-improving, increasingly accurate DOLP 209 with each teacher-student interaction, the DOC 211 is significantly better-suited to the student, providing curricula adapted to the student's unique learning style in content and quality.

The dynamic learning system devises the optimal curricular guidelines to the instructor, who in turn transmits the curriculum to the student. The instructor retains some flexibility in delivering the lesson, but is expected to follow the dynamic learning system guided curriculum.

Continual Optimization

With increased teacher-student interaction and the dynamic learning system usage, the responsive data RD 205 increases in number and the resultant DOLP 209 and DOC 211 become increasingly compelling. While perfection may never be reached, near-optimal curricula will eventually result.

Unlike the DOLP 209, the Teaching Profile TP is not necessarily always dynamically updated, as the instructor is guided by the system-generated DOC 211. While the instructor continues to exhibit those innate characteristics reflected in her teaching profile TP, her actions are continually guided by the system's direction. Instructor evaluation data may be continually updated for the TP.

The teaching profile may be dynamically updated to create a Dynamically Optimized Teaching Profile DOTP. FIG. 6 shows a flow chart for such operation. FIG. 7 shows a routine for periodically analyzing the DOTP against the DOLP to select an optimal instructor after the initial selection.

FIG. 3 shows an operation flow chart for the dynamic learning system of the invention. When the student logs in at 300 it is first determined at 301 if this is the first use. If it is the first use, the Preliminary Phase 100 shown in FIG. 1 is performed and then the Main Phase 200 shown in FIG. 2 is performed. More particularly, the Main Phase is broken down into its steps. After the Preliminary Phase 100, the Provisional Curriculum PC is obtained at step 302. Then the system proceeds to provide instruction at step 310. Responsive data is captured at step 311. The present affect value aV is determined at step 312. The success rate is determined at step 313. The affect value aV and the success rate SR are stored at step 314. The learning profile is also adjusted at step 314. The learning curriculum is adjusted at step 315. Then the learning curriculum is accessed at step 304 and the loop of operation continues with providing instruction at step 310. The loop of operation continues until the learning session is terminated.

If it is not a first use, meaning there is already a Dynamically Optimized Learning Profile, the Preliminary Phase 100 is not performed. Instead, at 303, the system accesses the Dynamically Optimized Learning Profile DOLP. Based upon the learning profile, the system accesses the learning curriculum at step 304 and provides instruction at step 310. At this point the system is in a loop of operation. Responsive data is captured at step 311. The present affect value aV is determined at step 312. The success rate is determined at step 313. The affect value aV and the success rate SR are stored at step 314. The learning profile is also adjusted at step 314. The learning curriculum is adjusted at step 315. Then the learning curriculum is again accessed at step 304 and the loop of operation continues with providing instruction at step 310. The loop of operation continues until the learning session is terminated.

Computer System

FIG. 4 shows a computer and data processing system for the dynamic learning system of the invention. Referring to FIG. 4, FIG. 4 depicts a schematic diagram of data processing system 400. Data processing system 400 is programmed with the software for performing the steps and functions of FIGS. 1-3.

Data processing system 400 receives data input by a student 1 via input/output devices 401 or directly from sensors 402. The data is input to local computer 404 at Location 1 via an interface 403. The computer 404 has a memory device 406 (not shown but similar to memory device 411) associated with it that includes both ROM and RAM. The computer 404 is connected to the internet (Web) 415 via an interface 405.

There may be numerous local computers for use by students or instructors. A local computer 409 is at Location X where the instructor 2 is connected to the data processing system. Data processing system 400 receives data input by instructor 2 via input/output devices 407. Information input/output from/to the instructor 2 is input/output to computer 409 via interface 408. The computer 409 has a memory device 411 associated with it that includes both ROM and RAM. The computer 409 is connected to the internet (Web) 415 via an interface 410. Thus, the student 1 and instructor 2 can communicate via the internet using technologies such as SKYPE or video conferencing.

FIG. 4 depicts an illustrative embodiment of data processing system 400, which further comprises: main computer 420, local input/output devices 423 for programming the computer and otherwise managing the system, data storage device (memory module) 422, interface 421 and an internet connection to the Web 415. Data storage device (memory module) 422 includes both ROM and RAM. Computer 420 is advantageously a general-purpose computer as is well-known in the art that is capable of:
executing one or more programs that are stored in data storage device (memory module) 422;
storing data in and retrieving data from data storage device 422;
inputting and outputting data to local input/output devices 423;
receiving data from and outputting data to data interface 421; and
receiving data from and outputting data to the Web via data interface 421.

Local input/output devices 401, 407 and 423 are devices (e.g., a printer, a tape drive, a CD player, a DVD player, a monitor, a keyboard, removable hard disk, floppy disc drive, a mouse, a microphone, a headphone, speakers, lap top or hand help device or cell phone screen or keyboard etc.) from which data from data processing system 400 can be input/output for processing or delivery to users (students/instructors/operators).

Data storage devices 406, 411 and 422 are each advantageously a non-volatile memory (e.g., a hard drive, a hard disk, a tape drive, memory chip or chips, an optical device, etc.) for storing the program code executed by computers 404, 409, and 420 and the data input into and generated by data processing system 400. Data storage devices 406, 411 and 422 are tangible memories and include ROM.

Data interfaces 405, 410 and 421 enable users to communicate with or display data from data processing system 400 via a data network, such as the Internet. For example, data processing system 400 can be accessed via the World Wide Web. Wireless connections may be provided.

It will be clear to those skilled in the art how to make and use computers 404, 409 and 420; local input/output devices 401, 407 and 423; data storage devices 406, 411 and 422; and data interfaces 405, 410 and 421 and any computer terminals for accessing the data interfaces. Although data processing system 400 is shown as depicting only one main computer 420 and one data storage device 422, it will be clear to those skilled in the art that a data processing system in accordance with the present invention can also comprise one or more such computers and one or more such storage devices. The system programming can be performed by computer 420 and stored in its associated data storage or performed by the computers at the locations of the student or instructor and stored there. There may be duplication of programming, programming storage and data storage at the different locations or the main center in accordance with practices known to those of skill in the art. Data storage on a Cloud network may also be used.

The assistance of one or more computers may be used for a number of other functions. For example, one or more computers may be used for voice recognition and speech synthesis. Computers may be used to generate statements and reports, to maintain records, etc. for one or more of the steps described above. Access to the software may be provided over local terminals, over the internet, from a central server array, or through other computer access networks or the Cloud. Some output may be generated by word processing software.

FIG. 5 shows the input and analysis of sensor data, test responses and instructor/observer input to arrive at data representing student characteristics stored as affect value data aV. Input sensors 402 may include an eye trace sensor, skin sensors, heart rate sensor, breathing sensor or other sensors to detect mood or psychological traits or affective states. The sensor data is recorded at 504 and analyzed at 505. Data from test questions 501 directed at mood or psychological traits or affective states, is recorded at 508. Instructor/observer input 502 regarding mood or psychological traits or affective states is also recorded at 508. Further, student manual input 503 regarding mood or psychological traits or affective states is recorded at 508. Recorded data from test questions 501, instructor/observer input 502 and student manual input 503, directed at mood or psychological traits or affective states, is preliminarily analyzed at 509 to obtain sensor free affective state data.

At 506 the Main Phase recorded data and the preliminary data obtained in the Preliminary Phase are further analyzed. The sensor based affective state data and the sensor-free affective state data are combined to obtain total aV data. Further Success Rate SR data is recorded and analyzed. The aV data and the SR data are stored for each delivery method. Preprogrammed relative weight values are employed or relative weight values are determined in order to combine the data from different sensor based sources, different sensor-free sources, different affective states, and sensor based/sensor-free affective state data. The weights are expressed as percentages based upon significance. Other algorithms or functions may be used to analyze and combine the data.

FIG. 6 shows a flow chart for creating a Dynamically Optimized Teaching Profile. FIG. 6 shows a flow chart for dynamically updating the teaching profile to create a Dynamically Optimized Teaching Profile DOTP.

The Provisional Teaching Profile 115 from the Preliminary Phase 100 is analyzed at 602 with teacher responsive data 601 from the Instructor 2. The teacher responsive data 601 is data about the instructor captured during the instruction (lessons). The result of the analysis is a Dynamically Optimized Teaching Profile DOTP 600. The DOTP is analyzed at 603 to output a teacher evaluation regarding the quality of instruction. The DOTP is analyzed at 605 to output teaching guidance to the instructor 606. Thus, the dynamically optimized learning system could guide the instructor to speak more slowly or louder. Periodically, the DOTP is analyzed by a subroutine 700 shown in FIG. 7 to select a new optimal instructor.

Table 5 shows examples of teacher characteristics that may be graded or evaluated.

TABLE 5
Grades for Teacher Performance of Skills

Grade Skill 1 - language proficiency
Grade Skill 2 - written lesson plans
Grade Skill 3 - preparedness
Grade Skill 4 - people skills
.
.
.
Grade Skill 100 - use of computer guidance

The teaching analysis portion of the system and method may be a mirror image of the learning analysis portion of the system. Everything done for the learning analysis can be done for teaching analysis including affect detection by sensors and sensor—free affect detection. This includes the storing of affect values and success rates, for different delivery methods and generation and comparison of frequency curves of affect values vs. success rate.

FIG. 7 shows an interrupt routine 700 for selecting an optimal instructor after the initial selection. FIG. 7 shows a routine for periodically analyzing at 701 the Dynamically Optimized Teaching Profile DOTP 600 against the Dynamically Optimized Learning Profile DOLP 209 to select an optimal instructor 702 after the initial selection. Thus, when the student has advanced and is now suited for a teacher who is better for teaching more advanced subject matter, or a different dialect or jargon, the routine of FIG. 7 will select a new optimal instructor. There may be other reasons for selecting a new instructor including poor teacher evaluation.

FIGS. 8a and 8b show RAM maps for the dynamic learning system of the invention. FIG. 8b shows some portions in more detail than FIG. 8a as well as some additional stored data. With reference to FIGS. 8a and 8b, on the left are shown the data stored in RAM for the student and on the right are shown the data stored in RAM for the instructor. In FIG. 8a, the data stored in RAM for the student includes: Student BAT Responses, the Provisional Learning Profile PLP, the Optimal Instructor, the Provisional Curriculum PC, Student Responsive Data to Instruction Captured by the System, Student Responsive Data to Instruction Captured by the Instructor, the Dynamically Optimized Learning Profile DOLP, the Dynamically Optimized Curriculum DOC, Real Time affect value aV data and Real Time success rate SR data. The data stored in RAM for the instructors includes: Teacher BAT Responses for teachers T1 to TX, Provisional Teaching Profiles PTPs for teachers T1 to TX, Teacher Responsive Data for the Selected Teacher Captured by the System, Teacher Responsive Data for the Selected Teacher Captured by the Student, and the Dynamically Optimized Teaching Profile DOTP. In an embodiment where the teaching analysis is a mirror of the learning analysis with affect detection, the RAM further stores affect value teacher data (aVT) and teacher success rate data (SR).

In FIG. 8b, the data shown stored in RAM for the student includes: 1) Student Responsive Data to Instruction Captured by the Instructor and 2) Student Responsive Data to Instruction Captured by the System. Student Responsive Data to Instruction Captured by the System includes 1) data from sensors, 2) BAT responses and 3) student input. The data from sensors is from Z sensors. The sensor data is designated S₁ to S_{Z}. Real Time affect value aV data for Y delivery methods is shown as aV_{DM1} to aV_{DMY}. The RAM also stores the relative weights for the affect value data aV_{DM1} to aV_{DMY}. For Y delivery methods Y weights are stored. The weights may be percentages. Real Time success rate SR data for DM1 to DMY is also stored.

The data stored in RAM for the selected instructor includes the mirror image or similar data to that for the student. The RAM stores 1) Teacher Responsive Data for the Selected Teacher Captured by the Student and 2) Teacher Responsive Data for the Selected Teacher Captured by the System. Teacher Responsive Data for the Selected Teacher Captured by the System includes 1) data from sensors, 2) BAT responses and 3) teacher input. The data from sensors is from W sensors. The sensor data is designated S₁ to S_{W}. Real Time affect value teacher aVT data for YY delivery methods is shown as aVT_{DM1} to aVT_{DMYY}. The RAM also stores the relative weights for the affect value data aVT_{DM1} to aVT_{DMYY}. For YY delivery methods YY weights are stored. The weights may be percentages. Real Time teacher success rate T SR data for DM1 to DMYY is also stored.

FIGS. 9a and 9b show RAM maps for the dynamic learning system of the invention. With reference to FIG. 9a, on the left are shown the data stored in RAM for Learning Analysis Memory and on the right are shown the data stored in RAM for Teaching Analysis Memory. The data stored in RAM for Learning Analysis Memory includes: Learning Pedigree Variables, L aV Data (learning affect value data), L aV FCs (frequency curves), L aV Weights (the weight to be given to each L aV frequency curve), Learning CFCs (combined frequency curves) and Detected and Input Real Time aV data and Real Time SR data. The data stored in RAM for Teaching Analysis Memory includes: Teaching Pedigree Variables, T aV Data (teaching affect value data), T aV FCs (frequency curves), T aV Weights (the weight to be given to each T aV frequency curve), Teaching CFCs (combined frequency curves) and Detected and Input Real Time aVT data and Real Time T SR data.

FIG. 9b shows the memory mapped data of FIG. 9a for Learning Analysis Memory in more detail. Learning skill grades S₁ to S_{X} are shown. The L aV Data (learning affect value data) of FIG. 9a is shown. Data for each of aV v SR_{DM1} to aV v SR_{DMY} are shown. The L aV FCs (frequency curves) of FIG. 9a are shown for each of aV v SR_{DM1} FC to aV v SR_{DMY} FC in FIG. 9b. The L aV Weights (the weight to be given to each frequency curve) of FIG. 9a is shown as aV v SR_{DM1-Y} weights in FIG. 9b. FIG. 9b further indicates the learning combined frequency curves based upon the weights as Learning CFCs. A similar detailed memory map exists for the Teaching Analysis Memory.

FIG. 10 shows a detailed 3D RAM map for the dynamic learning system of the invention. In FIG. 10, L aV Data and L aV FCs shown in FIG. 9b are shown in more depth for each of content delivery methods DM1 to DMY. In the example shown, the first content delivery method DM1 is visual stimuli and L aV data and SR data are stored for each of data points: data point₁, data point₂, data point₃, data point₄ . . . data pointᵢ. The data for the L aV and SR is continually recorded. Frequency curves are continually generated and stored as FC_{aV v SRDM1}, where DM1 is visual stimuli. In other words, the content is taught by using visual teaching methods

Similar data is stored for other content delivery methods DM2 to DMY. For example, data is shown for DM2 which is verbal stimuli in the example. Similar data is stored for DMY which is any other content delivery method, designed as ó in the example.

Frequency curves FC_{aV v SRDM2 to} FC_{aV v SRDMY} are generated and stored.

FIGS. 11 and 12 show sample frequency curves for the dynamic learning system of the invention. Shown in FIG. 11 is a sample frequency curve for FC_{aV vSRDM1}. Affect value aV is graphed against the success rate SR. FIG. 11 is for the content delivery method of visual stimuli. Thus, the curve shows how the affect value aV varies with the success rate SR or responsiveness for visual stimuli. Shown in FIG. 12 is a sample frequency curve for FC_{aV v SRDM3}. FIG. 12 is for the content delivery method of written words. Thus, the curve shows how the affect value aV varies with the success rate SR or responsiveness for written words. The frequency curves are weighted based upon significance. The frequency curves for the various delivery methods are compared to determine the best delivery method or manner of learning for the current affect value.

FIGS. 13 and 14 show ROM maps of the dynamic learning system of the invention. With reference to FIG. 13, the ROM stores: the Default Learning Profile DLP, the Student BAT, Programs to Analyze the Student BAT Responses, Programs to modify the Default Learning Profile DLP with analysis of Student BAT responses to get the Provisional Learning Profile PLP, Programs to Analyze the Provisional Learning Profile PLP and the Provisional Teaching Profile PTP and Match the Student With the Optimal Instructor, the Default Curriculum DC, Programs to Analyze the Provisional Learning Profile PLP and to modify the Default Curriculum DC to get the Provisional Curriculum PC, Programs to Analyze Student Responsive Data to Instruction and the Provisional Learning Profile PLP to get the Dynamically Optimized Learning Profile DOLP, Programs to Analyze the Provisional Curriculum PC and the Dynamically Optimized Learning Profile DOLP to get the Dynamically Optimized Curriculum DOC, and Programs to Input and Detect real time aV data and real time SR data. The ROM further stores Programs to adjust the Dynamically Optimized Learning Profile DOLP and Programs to adjust the Dynamically Optimized Curriculum DOC.

As shown in FIG. 13, the ROM also stores the Default Teaching Profile DTP, the Teacher BAT, Programs to Analyze Teacher BAT Responses, Programs to modify the Default Teaching Profile DTP with analysis of Teacher BAT responses to get the Provisional Teacher Profile PTP, Programs to Analyze Teacher Responsive Data to get the Dynamically Optimized Teacher Profile DOTP, Programs to Analyze the Dynamically Optimized Teacher Profile DOTP to output guidance to the instructor, Programs to Analyze the Dynamically Optimized Teacher Profile DOTP to output an evaluation of the teacher's performance, and Programs to Input/Detect real time aVT data and real time T SR data. The ROM also stores Programs to adjust the Dynamically Optimized Teacher Profile DOTP. The ROM may also include search engine programming to match the student and instructor. These programs are readily available or within the level of one of ordinary skill to write without undue experimentation at the time of filing.

With reference to FIG. 14, the ROM stores: software for Voice Recognition and Speech Synthesis. The ROM stores Subject Matter Lessons, Programs to provide lessons in differing delivery methods, Programs to provide lesson guidance for differing delivery methods, and Programs to provide lessons in varying percentages of differing delivery methods. The ROM includes Programs to Generate Frequency Curves, Programs to Generate Combination Frequency Curves, Programs to determine weights of Frequency Curves, and Programs to determine outputs of % of delivery methods. For the student, the ROM stores: Programs to Analyze Sensor Data, Programs to Combine analysis from numerous sensors, Programs to Analyze Test Responses for Mood/Psychological State Characteristics for affective state, Programs to Analyze Sensor/Testing/Instructor Input to get Student Characteristic affect value data and SR data, Programs to determine aV based on sensors, Programs to determine aV based on sensor-free methods, Programs to combine sensor and sensor-free aV data, Programs to determine SR, Programs to Test for Best Manner of Content Delivery Student Learns By, Programs to Analyze Responsive Data to Determine Best Manner of Content Delivery Student Learns By, Programs to Test for other characteristics, Programs to Analyze Responsive Data to Determine other characteristics, Programs to Test for the student's proficiency of subject matter, Programs to Analyze Responsive Data to Determine the student's proficiency of subject matter and Programs to modify curriculum based upon % of delivery method.

For the instructor, the ROM stores: Programs to Analyze Teacher Sensor Data, Programs to Combine analysis from numerous teacher sensors, Programs to Analyze Test Responses for Teacher Mood/Psychological State Characteristics for affective state, Programs to Analyze Sensor/Testing/Student Input to get Teacher Characteristic affect value data and T SR data, Programs to determine aVT based on sensors, Programs to determine aVT based on sensor-free methods, Programs to combine sensor and sensor-free aVT data, Programs to determine T SR, Programs to Test for Manner of Teaching, Programs to Analyze Responsive Data to Determine Manner of Teaching the Instructor uses, Programs to Test for other teacher characteristics, Programs to Analyze Responsive Data to Determine other teacher characteristics, Programs to Test for quality of teaching, and Programs to Analyze Responsive Data to Determine quality of teaching. These programs are readily available or within the level of one of ordinary skill to write without undue experimentation at the time of filing.

Applicability

The dynamic learning system is a fundamental module which can be implemented in various educational platforms as a whole, modifying the algorithms according to any particular educational field. Alternatively, it can be integrated into already-existing technologies that may be static in nature, adding to them dynamic adjustive capacity. Platforms that are particularly well-suited and ripe for such implementation or integration are:

Language learning

Test Preparation

Online courses (all levels and subject matter)

One on one tutoring in any discipline.

Potential Use in Markets

The dynamic learning system has potential use in the following markets:

a. Online language instruction entities

b. Existing distance learning entities

c. Not-for-profit educational entities

d. Educational institutions

e. Corporate institutions.

A Video Conference (“VC”)

Much online learning involves live video feeds between instructor and student. The dynamic learning system depends to a significant extent upon this visual aspect of the communication, as this enables the system to capture various visual and auditory nuances, e.g., facial reactions and gestures, pronunciation, accent, dynamics.

Synchronous Learning

Web-based learning offers many benefits unavailable otherwise. The platforms employing the dynamic learning system will reap the benefits of these unique offerings. They include:

a. Enhanced accessibility (e.g., time zones)

b. Enhanced content breadth (e.g., dialect)

c. Enhanced content depth (e.g., tango, law)

d. Enhanced searchability

e. Diminished cost (e.g., overhead)

f. Lucrative emerging markets (e.g., business executives, elderly).

g. Enhanced market adaptability (e.g., modern marketplace).

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. In many cases, one feature or group of features may be used separately from the entire apparatus or methods described. For example there is a pause function, to pause the recording of data for any session or portion of a session. Based upon the current affect value, the system may terminate a session. Thus, if the affect value determined indicates that a student is too tired, the session will be terminated. Data may be erased if a session is terminated to not affect the recorded data in the profile.

There may be simple or requested modes of operation for example as in Table 6 where normal recoding of data may be suspended. There may be other simple or requested modes besides those listed.

TABLE 6
Simple or requested modes

Read alone mode
Homework mode
Take notes mode
Review notes mode
Play a recording with word or phrase repetition
Replay a particular lesson selected
Play a recording of memory lessons for vocabulary
Play a recording of conjugations

An embodiment may eliminate much of the sensor affect detection or sensor-free affect detection and determination of affect values and success rates, generation and analysis of frequency curves on the teacher side of the system. Such an embodiment is focused on student affective state analysis.

The dynamic optimized learning system of the invention may capture statistics on effectiveness of various teachers relative to students with different learning profiles. For example, the system may determine that one particular teacher is particularly effective with students with a high degree of responsiveness to visual stimuli.

The dynamic optimized learning system of the invention may function as an independent assistant tool for the instructor. Alternatively, it may be integrated into existing programs.

The preferred embodiment employs the dynamic optimized learning system and method for language learning, but the dynamic optimized learning system and method can be used for learning other subject matter and fields of knowledge. Many of those undescribed variations, modifications and variations are within the literal scope of the following claims, and others are equivalent.

What is claimed is:

1. A learning method, comprising the machine executed steps of:
creating a learning profile of a student based upon testing said student; and
dynamically optimizing said learning profile of said student based upon student responsive data to instruction.

2. The method of claim 1, further comprising the steps of dynamically optimizing a curriculum based upon said dynamically optimized learning profile of said student and providing lessons to said student or lesson guidance to an instructor based upon said dynamically optimized curriculum.

3. The method of claim 1, further comprising the dynamically optimized learning profile storing data regarding affective state.

4. The method of claim 1, further comprising the dynamically optimized learning profile storing data regarding the method of content delivery the student best learns by.

5. The method of claim 1, further comprising the dynamically optimized learning profile storing data regarding success rate.

6. The method of claim 3, further comprising the data regarding affective state being real time frequency curves of affect value versus success rate.

7. The method of claim 1, further comprising outputting instruction guidance to an instructor based upon said dynamically optimized learning profile.

8. The method of claim 6, further comprising frequency curves of affect value versus success rate for more than one delivery method.

9. The method of claim 8, further comprising comparing frequency curves of affect value versus success rate for more than one delivery method to obtain optimal relative percentages of delivery methods.

10. The method of claim 1, further comprising creating a teaching profile storing data regarding teaching characteristics.

11. The method of claim 10, further comprising dynamically optimizing said teaching profile.

12. The method of claim 10, further comprising matching said teaching profile to said learning profile to select an optimal instructor for said student.

13. The method of claim 11, further comprising providing guidance to said teacher based upon said teaching profile.

14. The method of claim 10, further comprising providing output evaluating said teacher.

15. The method of claim 1, wherein said method is for learning language.

16. The method of claim 3, further comprising sensor-free determination of affective state.

17. The method of claim 3, further comprising inputting sensor data to determine affective state.

18. A computerized data processing system, comprising at least one data processor configured to execute machine readable instructions, the data processor upon execution of instructions, controls the data processing system to perform the machine executed steps of:
creating a learning profile of a student based upon testing said student; and
dynamically optimizing said learning profile of said student based upon student responsive data to instruction in real time.

19. The computerized data processing system of claim 18, further comprising executing the steps of:
dynamically optimizing a curriculum based upon said dynamically optimized learning profile of said student and providing instruction to said student based upon said dynamically optimized curriculum or curricular guidance.

20. A data processing system, comprising:
data processor;
tangible memory modules, said memory modules having embedded therein computer readable instructions and stored therein a dynamically optimized learning profile of a student; and
said instructions for dynamically optimizing said learning profile in real time.

21. The apparatus of claim 20, further comprising:
a dynamically optimized curriculum stored in said memory modules and
computer readable instructions embedded in said memory modules, said instructions for dynamically optimizing said dynamically optimized curriculum in real time.
